(19) United States
(12) Patent Application Publication
(10) Pub. No.: US 2005/0174371 A1
(43) Pub. Date: Aug. 11, 2005

(54) Process for monitoring dispensing of dispensable compositions

(76) Inventors: Sudhir Govind Deshmukh, Voorhees, NJ (US); Christine Darlene Ames Polarine, Spring City, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/775,572

(22) Filed: Feb. 9, 2004

(51) Int. Cl. B41J 2/195

(52) U.S. Cl. 347/7

(57) ABSTRACT

The present invention is directed to a process dispensing of one or more dispensable compositions, such as ink jet ink and a monitoring device used therein. The process includes reading with an interrogator current dispensable composition information disposed on identification tags affixed to reservoirs positioned in a dispensing device. The reservoirs containing the dispensable compositions and the current information is stored on a host computer in communication with a client computer of the device, or on said client computer and said host computer. The process is terminated if the current information does not match with stored dispensable composition information of the dispensable. The dispensing process is commenced if the current information matches with the stored information. The current information on the tags is then updated by using the interrogator. The updated information then becomes current information in a subsequent dispensing cycle. The process can be to ensure dispensing of compositions of approved quality. The process can be also used to control the inventory by replenishing just in time any dispensed compositions, such ink jet inks used in photographic or textile prints.

### FIELD OF INVENTION

The present invention is directed to monitoring the dispensing of dispensable compositions and more particularly directed to monitoring the dispensing of ink jet inks from ink jet printers and device used therefor.

### BACKGROUND OF INVENTION

One of the typical dispensing processes includes digital inkjet printing process. It is a non-impact printing process in which, in response to a predetermined program, droplets of ink (liquid solutions or particle suspensions) are deposited on target substrates (also known as print media), such as paper, textiles, plastic, film, wood and metal substrates, to form a desired image or text thereon. In such a dispensing process, droplets of dispensable compositions, such as ink jet inks are dispensed through ink jet print heads of ink jet printers onto a target substrate in accordance with a predetermined program comprising digital data signals. The foregoing can be accomplished by using variety of jet printers, including, for example, impulse or drop-on-demand ink jet printers. In such printers, the target substrate moves relative to the print heads, or the print heads positioned in carriages move relative to the target substrate. A conventional impulse or drop-on-demand ink jet printer is typically provided with one or more chambers having one or more ejection orifices. A droplet of ink is ejected from the orifices in response to a contraction of volume in the chamber typically caused by energizing a transducer made from, for example, a piezo-electric material or by thermally expanding the ink drops before their ejection (thermal jet printer). Ink jet printers employing impulse or drop-on-demand ink jets typically have the same resolution in both the X and Y direction. This resolution permits a wide range of printing, including bar codes as well as alphanumeric characters. U.S. Pat. No. 4,901,093, which is entitled “Method and Apparatus For Printing With Ink Jet Chambers Utilizing a Plurality of Orifices”, describes a typical drop-on-demand ink jet printer.

Some ink jet printers make use of an ink jet print head mounted within a carriage traversed back and forth across a target substrate. In operation, the movement of the print head across the target substrate is controlled by a main control system that also acts to activate the print head to deposit or eject ink droplets onto the target substrate to form images or text, or both. Ink is provided to the print head by a supply of ink that is either stored in the reservoirs positioned on a movable carriage or in the reservoirs that can be mounted on a stationary frame of the printer that does not move with the carriage. For the case where the ink supply is not positioned on the carriage, the ink supply can be intermittently or continuously supplied to the print head for replenishing the ink supply in the print head. In either case, the replaceable printing components, such as the ink reservoir and the print head, require periodic repair and/or replacement. When the supply of the dispensable composition, such as ink jet ink, is exhausted, it can be replenished by either replacing the empty cartridge, by replacing the reservoir containing the dispensable composition, by adding the dispensable composition to the reservoir. The print head can be repaired, as needed, or replaced at the end of the print head life.

In order to ensure a reliable dispensing operation, it is known to monitor the supply of dispensable compositions such as, for example, ink jet inks. U.S. Pat. No. 6,467,888 describes a fluid delivery system that provides a detection mechanism that ascertains whether an inserted fluid bottle is an appropriate fluid bottle having fluid media that are compatible with the fluid jet printing system (e.g., within the specifications of the printing system and suitable for use with the other components of the ink jet printing system). The micro-controller of the intelligent fluid delivery system may be programmed to record and store information relating to the fluid bottle and the fluid media that may be useful when servicing the printing system. The fluid delivery system also improves the reliability of fluid delivery and fluid management by preventing/reducing the use of unknown or non-compatible fluid media.

However, a need still exists to remotely monitor the dispensing process whereby the supplier of dispensable compositions can monitor the process readily and supply the inventory when consumed.

### STATEMENT OF INVENTION

The present invention is directed to a process for monitoring dispensing of one or more dispensable compositions comprising:
(A) reading a current dispensable composition information disposed on identification tags affixed to reservoirs positioned in a dispensing device, said reservoirs containing said dispensable compositions and wherein said current information is stored on a host computer in communication with a client computer of said device, or on said client computer and said host computer;
(B) terminating said process if said current information does not match with a stored dispensable composition information of said dispensable compositions stored on said host computer, or on said client computer and said host computer; or
(C) continuing said process if said current information matches with said stored information, said process further comprising:
   (C1) dispensing one or more said dispensable compositions in accordance with a dispensing program through one or more dispensing heads of said dispensing device,
   (C2) generating updated dispensable composition information of said dispensable compositions,
   (C3) writing said updated information to said identification tags, and
   (C4) storing said updated information on said host computer, or on said host computer and said client computer.

The present invention is further directed to a process for monitoring dispensing of one or more ink compositions comprising:
(A) receiving from a client computer of a dispensing device a current dispensable composition information disposed on identification tags affixed to reservoirs positioned in said dispensing device, said reservoirs containing said dispensable compositions and wherein said current information is stored on a host computer in communication with said client computer;
(B) instructing means for dispensing of said device to terminate said process if said current information does not match with a stored dispensable composition information of said dispensable compositions stored on said host computer, or on said client computer and said host computer; or
(C) instructing said device to continue said process if said current information matches with said stored information, said process further comprising:
   (C1) receiving updated dispensable composition information of said dispensable compositions from said client computer; and
   (C2) storing said updated information on said host computer, or on said host computer and said client computer.

The present invention is also directed to a dispensing device comprising:
(A) a client computer usable storage medium located in a client computer of said device, and a host computer usable storage medium located in a host computer in communication with said client computer;
(B) one or more reservoirs containing dispensable compositions, said reservoirs being positioned in said device and having identification tags affixed thereto;
(C) means for dispensing one or more said dispensable compositions through one or more dispensing heads, said means for dispensing being in communication with said client and said host computer;
(D) means for reading current dispensable composition information of said dispensable compositions disposed on said identification tags;
(E) means for writing updated dispensable composition information of said dispensable compositions to said identification tags; and
(F) computer readable program code means for dispensing one or more said dispensable compositions, said code means residing in said client computer usable storage and said host computer usable storage media, wherein said computer readable program code means comprise:
   (F1) means for configuring computer readable program code devices to cause said means for reading to read said current dispensable composition information and to store said current information on said host computer, or on said client computer and said host computer;
   (F2) means for configuring computer readable program code devices to cause said means for dispensing to terminate dispensing said dispensable compositions if said current information does not match with a stored dispensable composition information of said dispensable compositions stored on said host computer, or on said client computer and said host computer;
   (F3) means for configuring computer readable program code devices to cause said means for dispensing to dispense said dispensable compositions in accordance with a dispensing program if said current information matches with said stored dispensable composition information;
   (F4) means for configuring computer readable program code devices to cause said client computer or said host computer to generate said updated dispensable composition information of said dispensable compositions; and
   (F5) means for configuring computer readable program code devices to cause said means for writing to write said updated dispensable composition information to said identification tags and to store said updated information on said host computer, or on said client computer and said host computer.

### BRIEF DESCRIPTION OF DRAWING

FIG. 1 broadly illustrates one of the embodiments of the device of the present invention.

FIG. 2 broadly illustrates the dispensing means used in the device of FIG. 1.

FIG. 3 represents a flowchart that broadly illustrates computer readable program code means used in the device of the present invention illustrated in FIG. 1.

FIG. 4 provides further details of means for configuring computer readable program code devices to cause a client computer or a host computer to generate a current inventory shown in FIG. 3.

FIG. 5 provides further details of means for configuring computer readable program code devices to cause the client computer or the host computer to generate an updated inventory shown in FIG. 3.

### DETAILED DESCRIPTION OF PREFERRED THE EMBODIMENT

Dispensable compositions, such as ink jet inks are typically supplied in prepackaged ink cartridges or in disposable bags that can be nested in receptacles located in dispensing devices, such as printers. It should be understood that the term “dispensable composition” as used herein refers to compositions that include conventional ink jet inks, textile inks, electrically conductive inks, or biomaterials, that can be dispensed on target substrates, such as cellulose paper, polymeric film, polymeric laminate, woven fabric, non-woven fabric, biologically active substrate or a circuit board. The present invention provides for a device and a process used therein to monitor production of such compositions and more particularly directed to monitoring reservoirs containing ink jet inks.

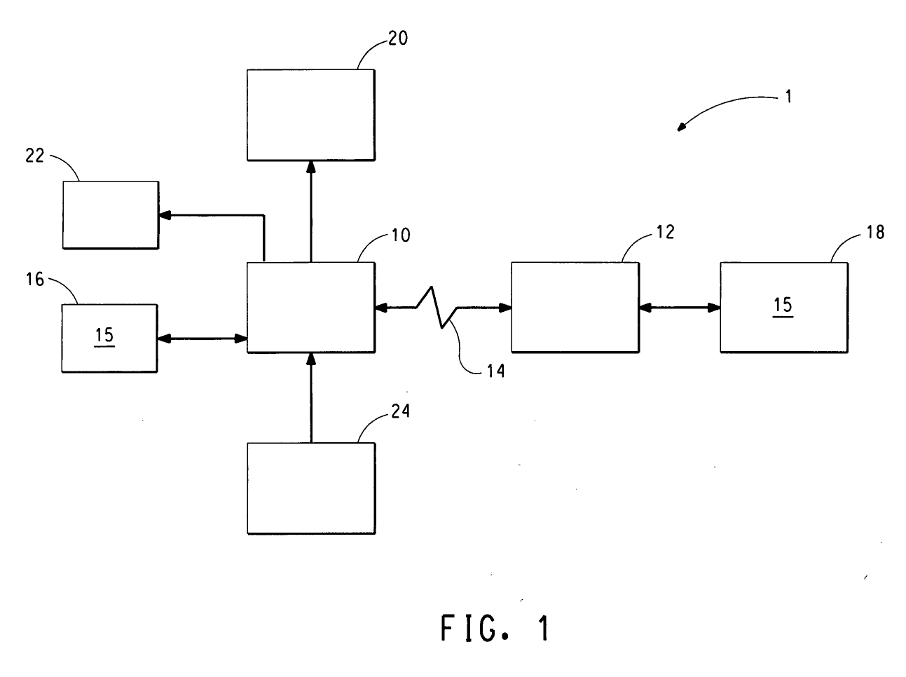

FIG. 1 illustrates the broadest aspects of the preferred embodiment of a dispensing device 1 of the present invention. Device 1 includes a client computer 10 and a host computer 12 in communication with client computer 10 via a conventional communication link 14, such as modem, Internet, local area network, or a wireless communication system. A conventional client computer usable storage medium 16 is located in client computer 10 and a conventional host computer usable storage medium 18 is located in host computer 12. Device 1 further comprises computer readable program code means 15 for dispensing one or more the dispensable compositions. Code means 15 can reside in client computer usable storage medium 16 and in host computer usable storage medium 18, or in host computer usable storage medium 18. Client computer 10 is preferably provided with a conventional monitor 20, a conventional printer 22 and a conventional key board 24. Client computer 10 and host computer 12 can be any known computer/processor such as those supplied by Dell Computer Corporation, Round Rock, Tex. or IBM Corporation, Armonk, N.Y. that can be configured to execute conventional computer program codes.

It should be understood that client computer 10 and host computer 12 can be located anywhere, such as for example computer 10 can be located in one country, such as the United States, or another state and host computer 12 can be located in another country, such as Canada, or another state. Alternatively, host computer 12 can be located in one country, such as United States, or another state and client computer 10 can be located in another country, such as Canada, or another state. It should be further understood that host computer 12 could be in communication with several client computers 10. Alternatively, client computer 10 could be in communication with several host computers 12.

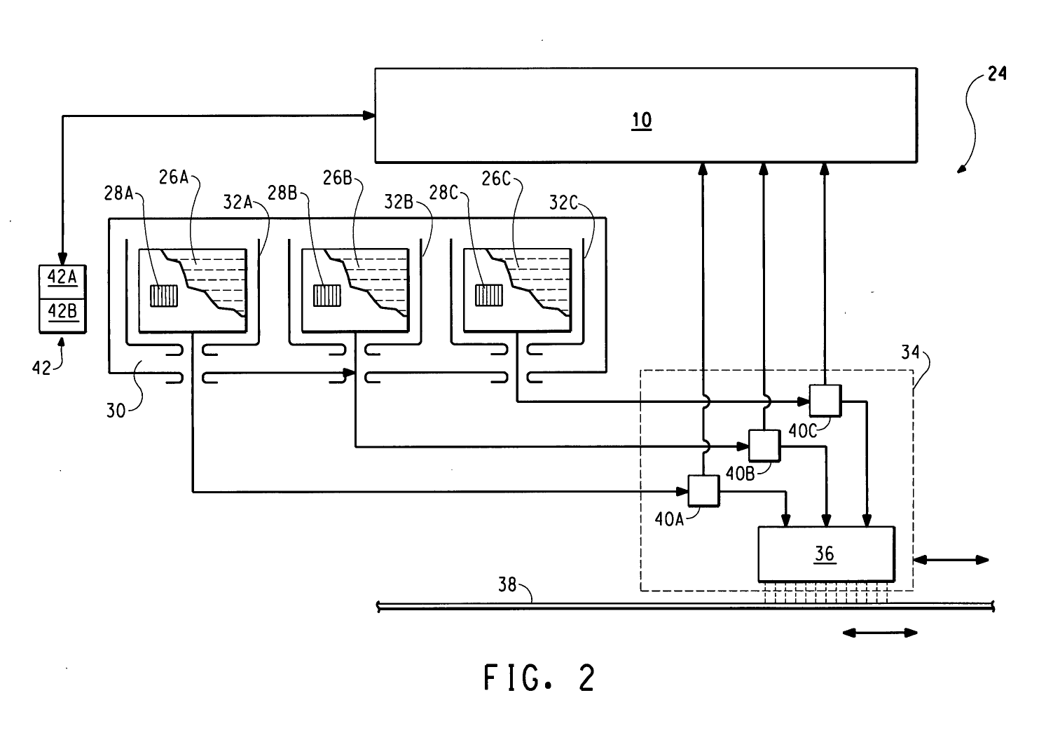

Device 1 further includes means 24 for dispensing, the details of which are provided in FIG. 2. Dispensing means 24 include one or more, by way example, conventional reservoirs 26A, 26B and 26C having identification tags 28A, 28B and 28C, respectively affixed thereto. However, its should be understood that device 1 of the present invention, if required, can contain more or less number of reservoirs than shown in FIG. 1. In one of the embodiment shown in FIG. 2, they are positioned on a rack 30. Alternatively, reservoirs 26A, 26B and 26C are preferably in the form of conventional disposable bags nested in conventional receptacles 32A, 32B and 32C, respectively positioned on rack 30. Reservoirs 26A, 26B and 26C are connected to convey the dispensable compositions contained in reservoirs 26A, 26B and 26C to one or more conventional dispensing heads 34, such a print head. Dispending head 34 is typically provided with one or more orifice plates 36, which is provided with a pattern of orifices though which the dispensable compositions can be conventionally ejected onto a target substrate 38 to create a pattern, such as an image, text, or both, thereon. The pattern can be produced by positioning dispensing head 34 on a conventional motorized movable carriage to produce relative a motion between target substrate 38 and heard 34. It is also conventional to position target substrate 38 on a conventional motorized tractor to produce the relative motion between head 34 and target substrate 38. Thus, a relative motion can be produced by either moving head 34, substrate 38, or both relative to one another to create the pattern on target substrate 38. Dispensing head 34 can further include conventional controllers 40A, 40B and 40C that can count the amount of dispensable compositions dispensed, typically in the form of drops, through the orifices on orifice plate 36. Such controllers have been described in U.S. Pat. No. 6,601,934, which is incorporated herein by reference. Depending upon the type of Reservoirs 26A, 26B and 26C being used, these reservoirs can be separate components as shown in FIG. 2 or they can be integrated with dispensing head 34 to form a disposable print cartridge, which can then be nested in receptacles positioned on a movable motorized printer carriage.

Dispensing means 24 further comprise one or more conventional means 42A for reading a current dispensable composition information of the dispensable compositions disposed on identification tags 28A, 28B and 28C and conventional means 42B for writing an updated dispensable composition information of the dispensable compositions to identification tags 28A, 28B and 28C. Means 42A and 42B, which are preferably integrated as part of a conventional interrogator 42, which is typically positioned near reservoirs 26A, 26B and 26C. Generally, the current dispensable composition information comprises current quantity of the dispensable composition contained in the dispensable composition reservoir, identity of the dispensable composition, compositional structure of the dispensable composition, price of the dispensable composition contained in the dispensable composition reservoir, serial number of the dispensable composition reservoir, place of manufacture of the dispensable composition, location of the dispensable composition reservoir, date of manufacture of the dispensable composition, date of expiration of the dispensable composition, toxicity information of the dispensable composition, MSDS of the dispensable composition, manufacturer of the dispensable composition and contact information thereof; or a combination thereof. Generally, the updated dispensable composition information comprises updated quantity of the dispensable composition contained in the dispensable composition reservoir, identity of the dispensable composition, compositional structure of the dispensable composition, price of the dispensable composition contained in the dispensable composition reservoir, serial number of the dispensable composition reservoir, place of manufacture of the dispensable composition, location of the dispensable composition reservoir, date of manufacture of the dispensable composition, date of expiration of the dispensable composition, toxicity information of the dispensable composition, MSDS of the dispensable composition, manufacturer of the dispensable composition and contact information thereof; or a combination thereof.

Aforedescribed tags 28A, 28B and 28C can be conventional RFID tags wherein the information contained in the tag can be read with interrogator 42, which can be a conventional RFID interrogator. RFID tag system is preferred. A basic RFID system typically includes a RFID interrogator that includes an interrogator antenna or coil, and a transceiver (with decoder); and a transponder provided with a transponder antenna or coil (RFID tag), wherein the transponder is electronically programmed with unique information. The interrogator antenna emits radio signals to activate the tag and read and write data to it. Antennas are the conduits between the tag and the transceiver, which controls the system's data acquisition and communication. Antennas, which are available in a variety of shapes and sizes can be built into a frame to receive tag data from articles passing or positioned near the frame. Frequently, the interrogator (also known as reader), which can be packaged with the interrogator antenna and the transceiver/decoder to can be configured either as a handheld or a fixed-mount device. The interrogator emits radio waves in ranges of anywhere from few millimeters to 30 meters or more, depending upon its power output and the radio frequency used. When an RFID tag passes through or near the electromagnetic zone, it detects the interrogator's activation signal. The interrogator decodes the data encoded in the tag's integrated circuit (silicon chip) and the data is passed to the host computer for processing.

RFID tags come in a wide variety of shapes and sizes and are categorized as either active or passive. Active RFID tags are powered by an internal battery and are typically read/write, i.e., tag data can be rewritten and/or modified. An active tag's memory size varies according to application requirements; some systems operate with up to 1 MB of memory. In a typical read/write RFID work-in-process system, a tag might transmit to a machine a set of instructions, and the machine would then report its performance to the tag. This encoded data would then become part of the tagged part's history. The battery-supplied power of an active tag generally gives it a longer read range. The trade off is greater size, greater cost, and a limited operational life (which may yield a maximum of 10 years, depending upon operating temperatures and battery type). RFID tags are preferably made tamper resistant to prevent their removal without damage from reservoirs 26A, 26B or 26C. Typical RFID tags and method of producing them is disclosed in the U.S. Pat. RE37,956E, which is incorporated herein by reference.

By contrast, passive RFID tags operate without a separate external power source and obtain operating power generated from the interrogator. Passive tags are consequently much lighter than active tags, less expensive, and offer a virtually unlimited operational lifetime. The trade off is that they have shorter read ranges than active tags and require a higher-powered interrogator.

RFID systems suitable for use in the present intention preferably operate at frequencies ranging from 125 KHz to 2.45 GHz. The significant advantage of all types of RFID systems is the non-contact, non-line-of-sight nature of the technology. Tags can be read through a variety of substances such as dirt, crusted grime, and other visually and environmentally challenging conditions, where barcodes or other optically read technologies would be useless. RFID tags can also be read in challenging circumstances at remarkable speeds, in most cases responding in less than 100 milliseconds. The read/write capability of an active RFID system is also a significant advantage in interactive applications of the process of the present invention.

Suitable RFID interrogators 42 include Model 915 or 2450 supplied by Alien Technology Corporation of Morgan Hill, Calif.; Fasttrack LRP or HMS models supplied by Escort Memory Systems of Scotts Valley, California; and Models MP9111, MP9112, MP9210, MP9320, and 13.56 all supplied by Samsys Technologies, Inc. of Richmond Hill, Ontario, Canada. Some of the typical combination bar code reader/RFID interrogators include Model 1555 supplied by Intermec Technologies Corporation of Everett, Wash.; or Model HHR supplied by Matrics, Inc. of Columbia, Md. Interrogator 42 can be a barcode label printer/RFID writer, such as Easycoder F2 or F4 supplied by Intermec Technologies Corporation if Everett, Wash. or Model R-140 or R-402 supplied by Zebra Technologies International of Vernon Hills, Ill. When reservoirs 26A, 26B and 26C are made of metal or metal alloy, such as steel, RFID tags 28A, 28B and 28C are preferably disposed on an insulated substrate, such as paper, plastic film, or a resinous coating, such as a painted surface, to insulate RFID tags 28A, 28B and 28C from the metal containers. Reservoirs 26A, 26B and 26C in the form of disposable bags made of chemically resistant and impervious resinous material, such as polyethylene, are preferred. For small devices, such as mini-printers where space for positioning interrogator 42 is limited SkyeRead M-1 mini RFID reader supplied by SkyeTek LLC of Boulder, Colo., which is about 25.4 millimeter in diameter can be employed.

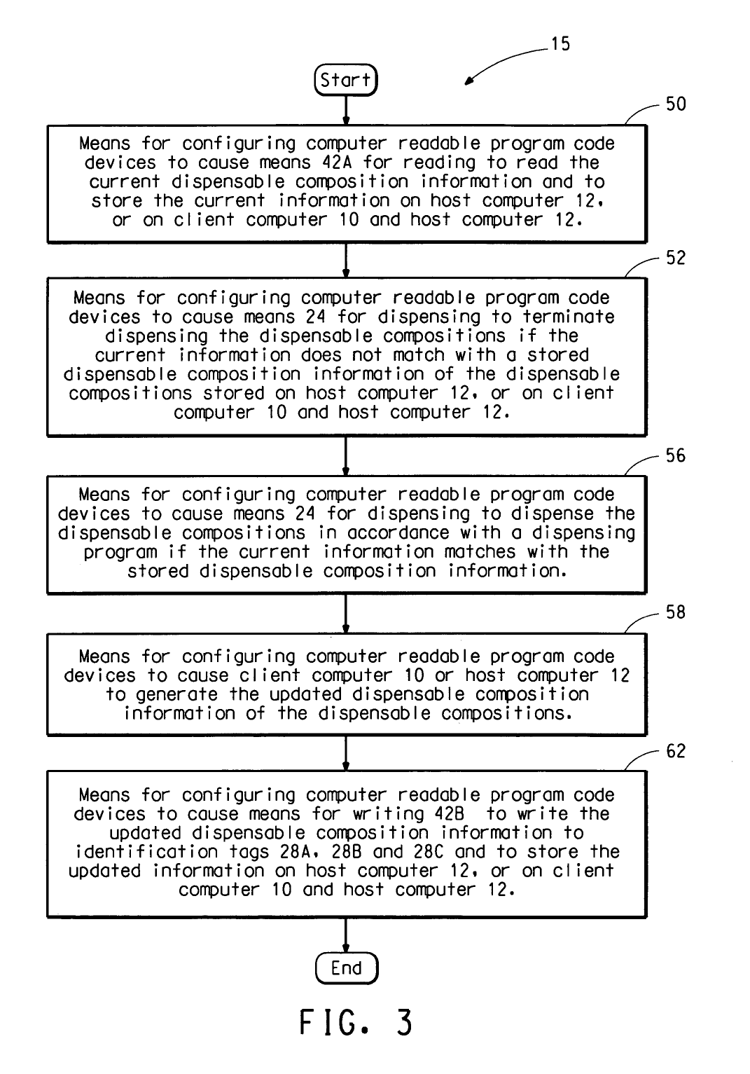

In device 1 client computer usable storage medium 16, host computer usable storage medium 18, or both have computer readable program code means 15 loaded therein for monitoring dispensation of dispensable compositions. Code 15 can be written by using conventional programming software, such as C++ Builder, Version 5 or Delphi, Version 6, both supplied by Borland Corporation located in Scotts Valley, California. Details of computer readable program code 15, shown in FIG. 3, comprise:

Means 50 for configuring computer readable program code devices to cause means 40A for reading to read the current dispensable composition information and to store the current information on host computer 12, or on client computer 10 and host computer 12.

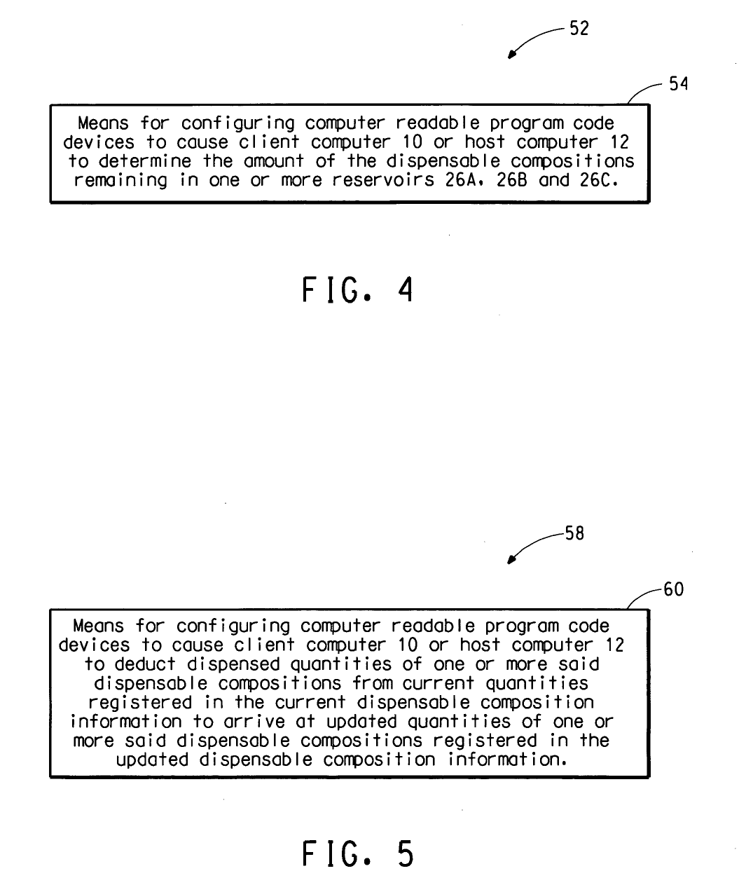

Means 52 for configuring computer readable program code devices to cause means 24 for dispensing to terminate dispensing the dispensable compositions if the current information does not match with a stored dispensable composition information of the dispensable compositions stored on host computer 12, or on client computer 10 and host computer 12. In addition, as shown in FIG. 4, means 52 can comprise means 54 for configuring computer readable program code devices to client computer 10 or host computer 12 to determine the amount of the dispensable compositions remaining in one or more reservoirs 26A, 26B and 26C. Means 54 can be further configured to terminate the dispensing of the dispensable compositions if one or more reservoirs 26A, 26B and 26C are empty. If desired, means 54 can be configured to then issue an alarm to the user to replace any of the empty reservoirs 26A, 26B and 26C with filled reservoirs or to replenish the dispensed quantities of the dispensable compositions in the reservoirs that are positioned in device 1.

Means 56 for configuring computer readable program code devices to cause means 24 dispensing to dispense, i.e., to commence dispensing, of the dispensable compositions in accordance with a dispensing program if the current information matches with the stored dispensable composition information.

Means 58 for configuring computer readable program code devices to cause client computer 10 or host computer 12 to generate the updated dispensable composition information of the dispensable compositions. As shown in FIG. 5, means 58 further comprise means 60 for configuring computer readable program code devices to cause client computer 10 or host computer 12 to deduct dispensed quantities of one or more said dispensable compositions from current quantities registered in the current dispensable composition information to arrive at updated quantities of one or more said dispensable compositions registered in the updated dispensable composition information. The dispensed quantities of the dispensable compositions can be counted by controllers 40A, 40B and 40C and the information on the dispensed quantities is then conveyed to host computer 12 or to client computer 10 and host computer 12.

Finally, means 15 also comprise means 62 for configuring computer readable program code devices to cause means for writing 42B to write the updated dispensable composition information to identification tags 28A, 28B and 28C and to store the updated information on host computer 10, or on client computer 10 and host computer 12. It should be understood that the updated information then becomes the stored information in a subsequent dispensing cycle.

Computer readable program code means 15 can be stored on a portable computer usable storage medium, such as a CD-Rom, that can be downloaded to host computer 12 or to client computer 10 and host computer 12.

The current information typically refers to the items that can be readily dispensed by device 1 before the dispensing of the dispensable compositions required in the dispensing program and as mentioned earlier it results from updating of the current information during the previous dispensing cycle. The stored information can be stored in storage media 16 and 18, or preferably on storage medium 18. Means 52 prevents dispensing of dispensable compositions that do not meet the quality requirement stipulated by the dispensable composition manufacturer, i.e., only the genuine pre-approved dispensable compositions can be used. Means 52 also prevent the user from refilling or reusing a previously used up reservoir (dead reservoir), such as a reservoir whose contents had been exhausted during earlier dispensing cycles. As a result, the manufacturer or the supplier of the dispensable composition can maintain up-to-date real time inventory of these items and can then readily re-supply these dispensable compositions based on the up-to-date real time information available from the stored information, which the manufacturer or the supplier can obtain by accessing the stored information residing on host computer 12 or on client computer 10 and host computer 12.

The present invention is also directed to a process for monitoring dispensing of one or more dispensable compositions. All the terms described in the following process are the same as those described earlier. In its broadest aspect the process includes:
(A) reading a current dispensable composition information disposed on identification tags 28A, 28B and 28C affixed to reservoirs 26A, 26B and 26C positioned in dispensing device 1, reservoirs 26A, 26B and 26C containing the dispensable compositions and wherein the current information is stored on host computer 12 in communication with client computer 10 of device 1, or on client computer 10 and host computer 12;
(B) terminating the process if the current information does not match with a stored dispensable composition information of the dispensable compositions stored on host computer 12, or on client computer 10 and host computer 12; or
(C) continuing the process if the current information matches with the stored information, the process further comprising:
(C1) dispensing one or more the dispensable compositions in accordance with a dispensing program through one or more dispensing heads 34 of dispensing device 1,
(C2) generating updated dispensable composition information of the dispensable compositions,
(C3) writing the updated information to identification tags 28A, 28B and 28C, and
(C4) storing the updated information on host computer 12, or on host computer 12 and client computer 10.

In step (A) of the process, said current dispensable composition information is read with one or more means 42A for reading identification tags 28A, 28B and 28C.

The foregoing process step (C2) further comprises deducting dispensed quantities of one or more the dispensable compositions from current quantities registered in the current dispensable composition information to arrive at updated quantities of one or more the dispensable compositions registered in the updated dispensable composition information.

In the foregoing process step (C3) the updated dispensable composition information is written with one or more means 42B for writing to the identification tags 28A, 28B and 28C.

In the foregoing step (C), the process is terminated if current quantities of the dispensable compositions registered in the current dispensable composition information exceed stored quantities of the dispensable compositions registered in the stored dispensable composition information.

The foregoing process further comprises replenishing some or all of the dispensable compositions dispensed in the foregoing step (C1).

Another embodiment of the process for monitoring dispensing of one or more ink compositions comprises:
(A) receiving from client computer 10 of dispensing device 1 a current dispensable composition information disposed on identification tags 28A, 28B and 28C affixed respectively to reservoirs 28A, 28B and 28C positioned in dispensing device 1, reservoirs 28A, 28B and 28C containing the dispensable compositions and wherein the current information is stored on host computer 12 in communication the client computer 10;
(B) instructing device 1 to terminate the process if the current information does not match with a stored dispensable composition information of the dispensable compositions stored on host computer 12, or on client computer 10 and host computer 12; or
(C) instructing means 24 for dispensing of device 1 to continue the process if the current information matches with the stored information, the process further comprising:
(C1) receiving updated dispensable composition information of the dispensable compositions from client computer 10; and
(C2) storing the updated information on host computer 12, or on host computer 12 and client computer 10.

The foregoing process further comprises replenishing some or all of the dispensable compositions dispensed by dispensing device 1.

The foregoing process can further include supplying some or all of the required items required to augment the updated inventory. As a result, most or all of all of the items could be made available for the subsequent use.

The process and device of the present invention is well suited for dispensing ink jet ink on print media. In addition, the process and device of the present invention is also well suited for dispensing a dispensable composition, in the form of electrically conductive ink on an insulated substrate to print electrically conductive circuit traces thereon to form, for example, RFID circuits including tag antennas of one of more RFID tags. The aforementioned electrically conductive inks can be obtained from Carclo PLC of Wakefield, United Kingdom or Conductive Inkjet Technology (CIT) of Royston, United Kingdom. The insulated substrate can be in the form of a conventional printed circuit board (PCB) or in the form of a flexible substrate, such as Mylar® polyester film or Pyralux® polyimide film, both supplied by DuPont Company, Wilmington, Del. In addition to a conductive component, the conductive ink can include other conventional components, such as, dispersants, conventional cross linkers and binders to form adherent electrically conductive circuit traces on the insulated substrates. After the deposition of conductive ink on the insulated film, it can be optionally baked to cure the conductive ink deposited on the substrate. The film can be supplied with a conventional self-adhesive coating, which is protected with a conventional peel off backing. It is contemplated that one sheet of the substrate can contain one or more circuits units, which then can be die cut or perforated to break off into individual circuit units, such as RFID tags. It is also conventional to include other components, such as conventional microchips, which would then be interconnected by the electrical traces produced by the process of the present invention. It would be also conventional to perform operations on the substrate, such as drilling or punching an array of openings on the substrate through which electrical components, such as microchips, resistors, capacitors and heat sinks can be installed to produce circuit boards. The foregoing operations can be performed before or after printing the electrical traces produced by the process of the present invention. It is also conventional to apply protective coatings on top of such circuit boards or to seal off such circuit boards in insulating and protective materials. The process of the present invention is well suited to produce RFID tags.

In addition, the process and the device of the present invention helps in eliminating the dispensing of poor quality substitute compositions; thereby preventing the production of sub-standard products, such as photographs or printed sheets. The integrity of the quality of the dispensable composition can be maintained by identifying each dispensable composition reservoir with a unique identification number, which can be stored by a dispensable composition manufacturer during the production of the dispensable compositions (becomes part of a stored information). As a result, the manufacturer can generate and maintain complete information, including the quantity contained in the reservoirs. As the contents in the reservoir are consumed, updated information can be transmitted to the manufacturer by allowing the manufacturer to access client computer 10 or host computer 12 that can be, alternatively, operated by the manufacturer. The updated information then becomes the current dispensable composition information in a subsequent dispensing cycle provided the user makes no unauthorized additions or deletions to the current information. Once the contents in a certain identified reservoir are consumed or depleted, the code associated with that reservoir is relegated to a dead-reservoir list. If the user, by commission or omission attempts to use the same reservoir by filling it with any other unrecognized dispensable composition, the current information would fail to match with the stored information, thereby terminating the process. Thus, the process of the present invention helps in ensuring the product quality of the composition.

Finally, since the manufacturer is aware of which dispensable compositions have been consumed, the manufacturer can automatically augment the user with those depleted dispensable compositions without going through a cumbersome formal request process from the user, thereby reducing the time require to supply the dispensable compositions consumed by the user. Moreover, the manufacturer can also assist the user in reducing his inventory by supplying the dispensable compositions, just in time as they are consumed. Moreover, the manufacturer can also bill the user on an “as-used-basis” for the cost of only the dispensable compositions actually consumed. As a result, the user's out-of-pocket cost can be reduced by substantially eliminating the user's need to maintain an extensive and expensive inventory of dispensable compositions.

The process of and device of the present invention can be readily adopted to dispense the dispensable compositions in form of biomaterials on a target substrate to create a two-dimensional or a three-dimensional array of biomaterials, such as peptides, polynucleotides (such as DNA or RNA), etc., which are used in typical diagnostic or screening devices. The process of the present invention would ensure that only a right type of biomaterial is positioned at a right place on the three-dimensional array. If the composition information does not match, the device of the present invention will not dispense the compositions. Thus, the quality control of the resulting substrates can be not only maintained but can be readily ascertained, as the process can readily provide a complete record of what was dispensed in what position and where the compositions came from. Thus, any accidental dispensing of incorrect compositions will be prevented. To produce an array, a target substrate would include regions (sometimes referenced as spots) of usually different sequences biomaterials arranged in a predetermined configuration on a substrate, which can be then coated with a permeable or non-permeable layer on top followed by another layer, all positioned in predetermined fashion. The arrays, when exposed to a sample, will exhibit a pattern of binding which is indicative of the presence and/or concentration of one or more components of the sample, such as an antigen in the case of a peptide array or a polynucleotide of particular sequence in the case of a polynucleotide array. The binding pattern could be detected, for example, by labeling all potential targets, for example, a DNA in the sample, with a suitable label, such as a fluorescent compound, and accurately observing the fluorescence pattern on the array. Typically, substrate surface would also contain activated or activating biomaterials to conduct the in-situ analysis. Some aspects of producing biopolymer array have been disclosed in U.S. Pat. No. 6,323,043, which is incorporated herein by reference. The present invention contemplates positioning series of carriages having series of dispensing heads thereon to dispense various biomaterials in any desired sequence. In addition to being used for diagnostic devices, the resulting substrates can be used in detecting environmental hazards, such as the presence of carbon monoxide, nerve gas, or other hazardous air transported materials, such as spores. The target substrates in the form of strips containing different patterns could be affixed on the uniforms of soldiers to detect the presence of any harmful air borne contaminants. A visual change on the strip would then alert the solider on the presence or absence of any airborne hazardous materials. The strips could also be used to readily detect sugar levels of a diabetic, or detect the presence or absence of a HIV antigen. The device could also be made portable enough to conduct DNA analysis at a crime scene to quickly identify a suspect.

Alternatively, the process and the device of the present invention can be used to produce a two-dimensional or three-dimensional array of clumps of animal or human cells, which then can be used to grow into complex tissues or even entire organs, such as liver or pancreas. To ensure quality, the dispensing heads of the device of the present invention would only dispense desired cells in a predetermined pattern on a scaffolding substrate. If the cell information disposed on tags on reservoirs, does not match with what has been programmed, no dispensing of the cells would occur. By dispensing alternate layers of non-toxic biodegradable gel and clumps of cell, all positioned in predetermined fashion, three-dimensional structures, such as human skin suitable application on burn victims, could be produced. By making the layers thin enough, the cells could fuse when they come in contact with other bits of tissues, cartilages, etc. Thus, similar to the dispensing different color inks from different print heads, different types of known cells could be dispensed to create complex structures comprising multiple cells. It is also contemplated, that some of the dispensable compositions being dispensed in a programmed pattern can include nutrients for cell growth. The substrates can be made permeable and exposed to oxygen rich atmosphere to provide oxygen intake to the deposited cells, such that circulatory networks can be created that provide nutrients and oxygen to the resulting cellular structures.

The features and advantages of the present invention will be more readily understood, by those of ordinary skill in the art, from a reading of the foregoing detailed description. It is to be appreciated those certain features of the invention, which are, for clarity, described above in the context of separate embodiments, can also be provided in combination in a single embodiment. Conversely, various features of the invention that are, for brevity, described in the context of a single embodiment, can also be provided separately or in any sub-combination. In addition, references in the singular can also include the plural (for example, “a” and “an” may refer to one, or one or more) unless the context specifically states otherwise.

1. A process for monitoring dispensing of one or more dispensable compositions comprising:
(A) reading a current dispensable composition information disposed on identification tags affixed to reservoirs positioned in a dispensing device, said reservoirs containing said dispensable compositions and wherein said current information is stored on a host computer in communication with a client computer of said device, or on said client computer and said host computer;
(B) terminating said process if said current information does not match with a stored dispensable composition information of said dispensable compositions stored on said host computer, or on said client computer and said host computer; or
(C) continuing said process if said current information matches with said stored information, said process further comprising:
(C1) dispensing one or more said dispensable compositions in accordance with a dispensing program through one or more dispensing heads of said dispensing device,
(C2) generating updated dispensable composition information of said dispensable compositions,
(C3) writing said updated information to said identification tags, and
(C4) storing said updated information on said host computer, or on said host computer and said client computer.

2. The process of claim 1 wherein in said step (A) said current dispensable composition information is read with one or more means for reading said identification tags.

3. The process of claim 1 wherein step (C2) comprises deducting dispensed quantities of one or more said dispensable compositions from current quantities registered in said current dispensable composition information to arrive at updated quantities of one or more said dispensable compositions registered in said updated dispensable composition information.

4. The process of claim 1 wherein in said step (C3) said updated dispensable composition information is written with one or more means for writing to said identification tags.

5. The process of claim 1 wherein in said step (C) said process is terminated if current quantities of said dispensable compositions registered in said current dispensable composition information exceed stored quantities of said dispensable compositions registered in said stored dispensable composition information.

6. The process of claim 1 wherein said current dispensable composition information comprises current quantity of said dispensable composition contained in said dispensable composition reservoir, identity of said dispensable composition, compositional structure of said dispensable composition, price of said dispensable composition contained in said dispensable composition reservoir, serial number of said dispensable composition reservoir, place of manufacture of said dispensable composition, location of said dispensable composition reservoir, date of manufacture of said dispensable composition, date of expiration of said dispensable composition, toxicity information of said dispensable composition, MSDS of said dispensable composition, manufacturer of said dispensable composition and contact information thereof; or a combination thereof.

7. The process of claim 1 wherein said updated dispensable composition information comprises updated quantity of said dispensable composition contained in said dispensable composition reservoir, identity of said dispensable composition, compositional structure of said dispensable composition, price of said dispensable composition contained in said dispensable composition reservoir, serial number of said dispensable composition reservoir, place of manufacture of said dispensable composition, location of said dispensable composition reservoir, date of manufacture of said dispensable composition, date of expiration of said dispensable composition, toxicity information of said dispensable composition, MSDS of said dispensable composition, manufacturer of said dispensable composition and contact information thereof; or a combination thereof.

8. The process of claim 1 further comprises replenishing some or all of said dispensable compositions dispensed in said step (C1).

9. The process of claim 1 wherein said identification tag is a RFID tag.

10. The process of claim 9 wherein one or more identification tag interrogators positioned near said reservoirs comprise said means for reading from and said means for writing to said tags.

11. The process of claim 10 wherein said identification tag interrogator is a RFID tag interrogator.

12. The process of claim 1 or 11 wherein said identification tag is a passive or active RFID tag.

13. The process of claim 12 wherein said passive or said active RFID tag is disposed on an insulated substrate.

14. The process of claim 1 wherein said reservoir is a disposable bag nested in a receptacle located in said dispensing device.

15. The process of claim 1 wherein said dispensable composition is an ink jet ink, electrically conductive ink, or biomaterial.

16. The process of claim 1 wherein in said step (C1) said dispensing composition is dispensed on a target substrate.

17. The process of claim 16 wherein said target substrate is a cellulose paper, polymeric film, polymeric laminate, woven fabric, non-woven fabric, a biologically active substrate, or a circuit board.

18. The process of claim 16 wherein said dispensable composition is electrically conductive ink deposited on said target substrate comprising an electrically insulated film.

19. The process of claim 18 wherein said target substrate is one or more RFID tags.

20. The process of claim 16 wherein said dispensable composition is biomaterial deposited on said target substrate comprising a biologically active substrate.

21. The process of claim 20 wherein said biologically active target substrate is a two-dimensional or a three-dimensional array used in diagnostic or screening devices.

22. The process of claim 16 wherein said dispensable composition comprises clumps or animal or human cells dispensed on said target substrate comprising a scaffolding substrate.

23. The process of claim 22 comprising growing tissues, organs, cells, skin grown on said scaffolding substrate.

24. A process for monitoring dispensing of one or more ink compositions comprising:
(A) receiving from a client computer of a dispensing device a current dispensable composition information disposed on identification tags affixed to reservoirs positioned in said dispensing device, said reservoirs containing said dispensable compositions and wherein said current information is stored on a host computer in communication with said client computer;
(B) instructing means for dispensing of said device to terminate said process if said current information does not match with a stored dispensable composition information of said dispensable compositions stored on said host computer, or on said client computer and said host computer; or
(C) instructing said device to continue said process if said current information matches with said stored information, said process further comprising:
(C1) receiving updated dispensable composition information of said dispensable compositions from said client computer; and
(2) storing said updated information on said host computer, or on said host computer and said client computer.

25. The process of claim 24 further comprising replenishing some or all of said dispensable compositions dispensed by said dispensing device.
